(19) United States
(12) Patent Application Publication
(10) Pub. No.: US 2013/0293521 A1
(43) Pub. Date: Nov. 7, 2013

(54) Power-up circuit, LCD Substrate, and Method for manufacturing LCD Panel

(71) Applicant: Liang Xu, Shenzhen (CN)

(72) Inventor: Liang Xu, Shenzhen (CN)

(21) Appl. No.: 13/516,751

(22) PCT Filed: May 4, 2012
(86) PCT No.: PCT/CN2012/075090

§ 371 Date: Jun. 18, 2012

(51) Int. Cl. G06F 3/038; G02F 1/1333; G09G 3/36

(52) U.S. Cl. 345/211; 445/3; 345/87

(57) ABSTRACT

The invention discloses a power-up circuit, an LCD substrate, and a method for manufacturing an LCD panel. The power-up circuit of a PSVA LCD panel includes a conductive lead connected with an external power supply, and a plurality of data lines for supplying power to pixel electrodes of the LCD panel. One end of each data line is coupled with the conductive lead, and the other end is electrically connected with at least one another data line when power is applied. In the invention, because different data lines are mutually connected, when one data line is disconnected, the disconnected line connected to the conductive lead can continuously achieve power supply; the disconnected line on the other end can be connected to other normal data lines and can achieve power supply through normal data lines. Thus, the fault is controlled within the range of a disconnected point; the conventional linear defects are reduced to point defects, thereby improving PSVA light alignment effect.

### TECHNICAL FIELD

The invention relates to the field of liquid crystal displays (LCD), and more particularly to a power-up circuit, an LCD substrate, and a method for manufacturing an LCD panel.

### BACKGROUND

With the development of information society, people enhance the requirement for display devices. To satisfy such requirement, several flat panel display devices, such as LCD, Plasma Display Panel (PDP), and Organic Light-Emitting Diode (OLED) display device, have developed rapidly in recent years. Among the flat plate display devices, the LCD is gradually replacing a cold cathode display device due to the advantages of low weight, small volume, and low energy consumption.

FIGS. 1a, 1b, and 1c show an LCD with Polymer Sustained Vertical Alignment (PSVA) in the prior art. With respect to liquid crystal, a reaction monomer is added in the original negative liquid crystal of PSVA. After a liquid crystal box is formed, the reaction monomer is polymerized under the condition of applying voltage to both ends of the liquid crystal box and intensification of ultraviolet light, to complete light alignment of the liquid crystal. In this process, light and electricity both are indispensable.

Actually, a first substrate 112 (array substrate) of PSVA generally has the following several graphics, as shown in FIG. 2,

1) Panel Figure Areas 119,

2) PSVA Power-up Terminal 123,

3) Conductive Leads 122 between PSVA Power-up Terminal and Panel.

When the array substrate of the PSVA liquid crystal box is disconnected in the panel figure areas, because an electric signal cannot be applied to a corresponding position of a disconnected data line, liquid crystal deflection in the corresponding position will be affected. When light alignment is performed subsequently through the ultraviolet light, a correct tilt angle cannot be formed and thus linear defects is formed in the corresponding positions. The linear defects cannot be repaired by a corresponding repair method.

### SUMMARY

In view of the above-described problems, the aim of the invention is to provide a power-up circuit, an LCD substrate, and a method for manufacturing an LCD panel capable of improving light alignment when linear defects occur.

The aim of the invention is achieved by the following technical schemes.

A power-up circuit of a PSVA LCD panel comprises a conductive lead connected with an external power supply, and a plurality of data lines for supplying power to pixel electrodes of an LCD panel. One end of each data line is coupled with the conductive lead, and the other end is electrically connected with at least one another data line when power is applied.

Preferably, the power-up circuit further comprises a connecting switch. One end of the data lines is coupled with the conductive lead, and the other end is electrically connected with at least one another data line through the connecting switch when power is applied. Both ends of the connecting switch are connected with different data lines. The connecting switch can ensure that when power is applied, different data lines are in a short circuit manner and that short-circuit under other conditions is avoided, thereby improving reliability.

Preferably, the conductive lead is three in number and the data lines are three in kind for respectively controlling three kinds of LCD panel pixel electrodes which correspond to different colors. The same kind of data lines is connected to the same conductive lead; different kinds of data lines are connected to different conductive leads. Generally, a display device employs primary colors to synthesize various color images. Thus, different voltages can be supplied according to requirements of pixels of different colors to achieve the purpose of accurately controlling the tilt angle. The control mode is flexible and thus favorable for improving product quality.

Preferably, the connecting switch is a Thin Film Transistor (TFT). A source electrode and a drain electrode of the TFT are respectively connected with two different data lines, and a gate electrode of the TFT is connected to a common switching lead. The pixels of PSVA are controlled by the TFT. Thus, the TFT is also used as the connecting switch and can be synchronously formed in the process of making the substrate without adding working procedures, thereby reducing production cost.

Preferably, a source electrode of a TFT is connected with a drain electrode of an adjacent TFT for controlling the same kind of data lines, and a drain electrode thereof is connected with a source electrode of another adjacent TFT for controlling the same kind of data lines. The source electrode and the drain electrode of the TFT are respectively connected with the same kind of two adjacent data lines; when all the TFTs are opened, any two data lines of the same kind are mutually short-circuited on one end of the TFTs. Any two data lines of the same kind can be mutually connected. Then, as long as one data line of the same kind is normal, the voltage can be transmitted to other disconnected data lines, with high reliability.

Preferably, two adjacent data lines of the same kind are regarded as one group and respectively connected to a source electrode and a drain electrode of a TFT. When all the TFTs are opened, the data lines of different groups are not mutually connected on one end of the TFTs. Thus, the number of the connecting switches can be reduced. For example, if there are N data lines, only N/2 connecting switches are needed.

Preferably, a source electrode of a TFT is connected with a drain electrode of an adjacent TFT, and a drain electrode thereof is connected with a source electrode of another adjacent TFT. The source electrode and the drain electrode of each TFT are respectively connected with two adjacent data lines; when all the TFTs are opened, any two data lines are mutually short-circuited on one end of the TFTs. The reliability is highest in this technical scheme. Then, as long as one data line is normal, the voltage can be transmitted to other disconnected data lines. Thus, even if a conductive lead is disconnected, corresponding data lines can obtain voltage from other conductive leads.

Preferably, two adjacent data lines are regarded as one group and are connected to a source electrode and a drain electrode of a TFT. When all the TFTs are opened, the data lines of different groups are not mutually connected on one end of the TFTs. Thus, the number of the connecting switches can be reduced. For example, if there are N data lines, only N/2 connecting switches are needed. Moreover, even if a conductive lead is disconnected, corresponding data lines can obtain voltage from other conductive leads.

Preferably, one end of the conductive lead is connected with a power-up terminal; one end of the switching lead is connected with a switching terminal.

An LCD substrate comprises a first substrate and a second substrate which are mutually opposite; a plurality of panel figure areas are arranged between the first substrate and the second substrate; the aforementioned power-up circuit of the PSVA LCD panel is arranged correspondingly in each panel figure area.

A method for manufacturing an LCD panel comprises the following steps:

A: correspondingly arranging a power-up circuit of a PSVA LCD panel in each panel figure area of an LCD substrate;

B: electrifying a conductive lead, and switching on all connecting switches for performing power-up ultraviolet alignment; and

C: performing cutting operation around the edges of each panel figure area for excising and cutting off all the connecting switches.

In the invention, because different data lines are mutually connected during light alignment, when a data line is disconnected, the non-disconnected part of the data line connected to the conductive lead is continuously supplied with electricity through the conductive lead; the disconnected line on the other end of the data line is supplied with electricity through other normal data lines which are connected with the disconnecting end. Thus, alignment fault is controlled within the range of a disconnected point; the conventional linear defects are reduced to point defects, thereby improving PSVA light alignment effect.

### BRIEF DESCRIPTION OF FIGURES

FIG. 1a is a schematic diagram of a transparent electrode of a pixel part of a PSVA;

FIG. 1b is a sectional view taken from line A-A′ of FIG. 1a in a power-off state;

FIG. 1c is a sectional view taken from line A-A′ of FIG. 1a in a power-up state;

FIG. 2 is a structural diagram of an array substrate;

FIG. 3 is a schematic diagram of example 1 of the invention;

FIG. 4 is a schematic diagram of example 2 of the invention;

FIG. 5 is a schematic diagram of example 3 of the invention;

FIG. 6 is a schematic diagram of example 4 of the invention;

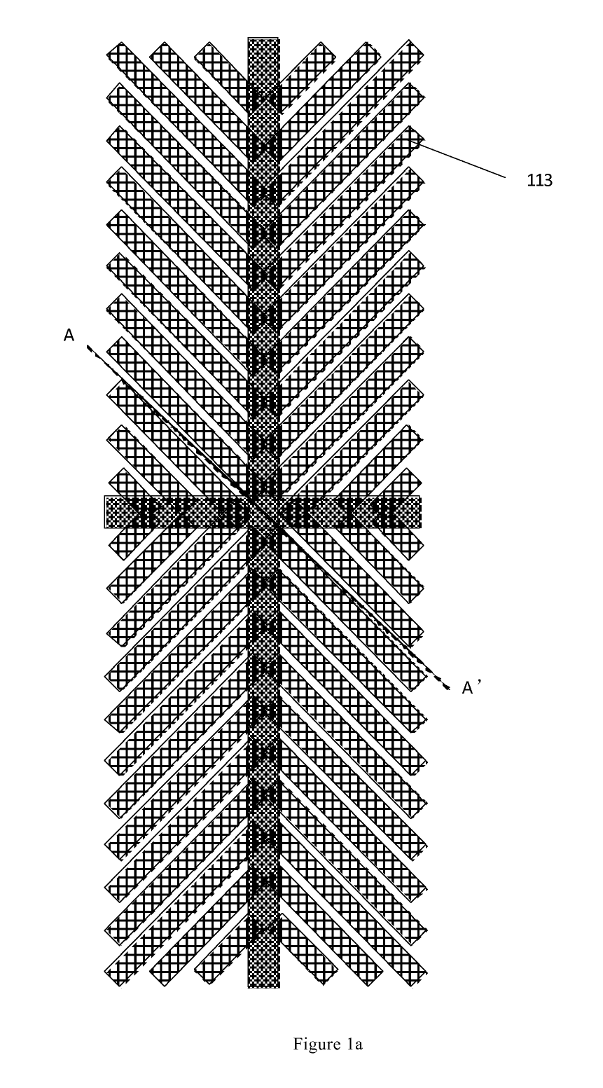

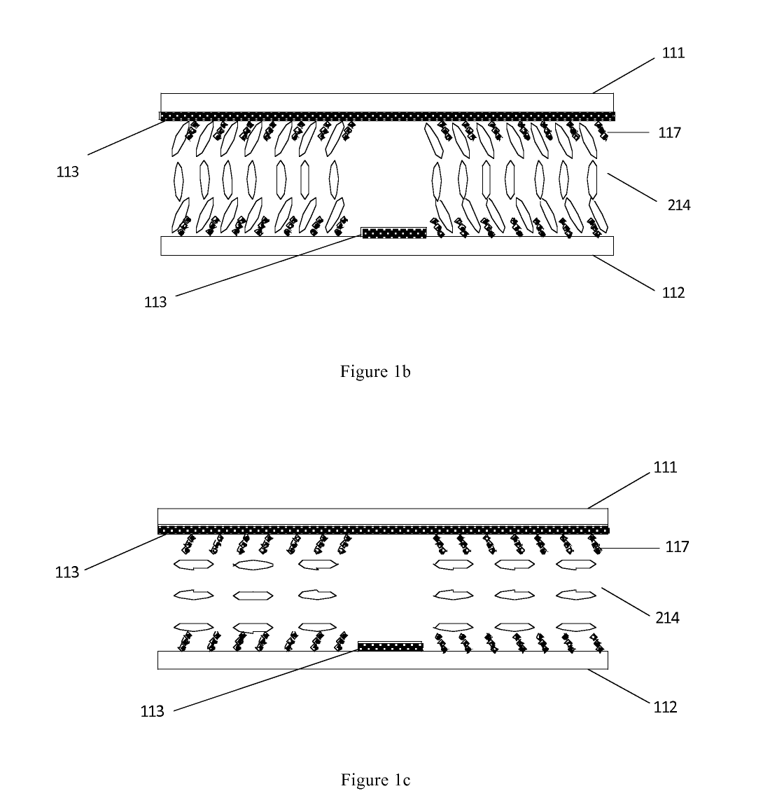

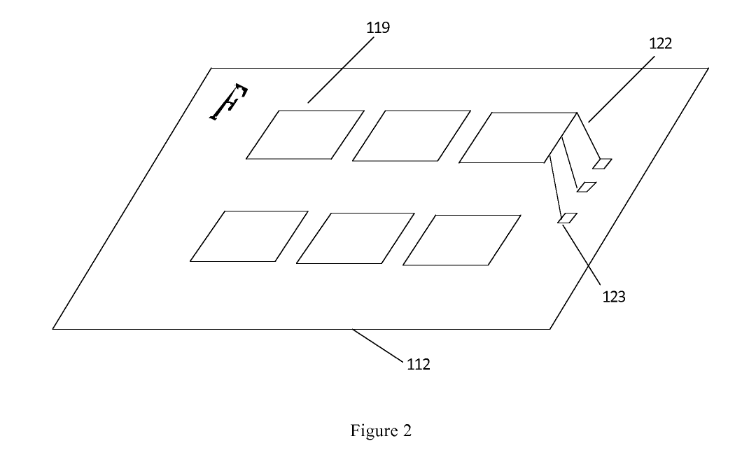

Legends: 111. second substrate; 112. first substrate; 113. transparent electrode; 117. polymerized polymer chain; 119. panel figure area; 122. conductive lead (lead between a polyreaction power-up terminal and panel figure area); 123. power-up terminal; 130. red pixel terminal; 131. green pixel terminal; 132. blue pixel terminal; 133. switching terminal; 134. red data line; 135. green data line; 136. blue data line; 137. TFT; 138. array substrate edge of LCD substrate; 139. color film substrate edge of LCD substrate; 140. switching lead; 150. data line; 214. negative liquid crystal containing reaction monomer.

### DETAILED DESCRIPTION

The invention will further be described in detail in accordance with the figures and the preferable examples.

An LCD substrate comprises a first substrate 112 and a second substrate 111 which are mutually opposite. The first substrate 112 is an array substrate; a plurality of panel figure areas 119 are arranged between the first substrate 112 and the second substrate 111. A power-up circuit of PSVA LCD panel is arranged correspondingly in each panel figure area 119. The first substrate 112 is the array substrate; the second substrate 111 is a color film substrate. A negative liquid crystal 214 containing a reaction monomer and a polymerized macromolecule chain 117 are clamped between the first substrate 112 and the second substrate. Generally, pixel electrodes which correspond to liquid crystals (i.e. transparent electrode 113) are arranged on the array substrate. Thus, the power-up circuit of the PSVA LCD panel is also arranged on the array substrate. The power-up circuit comprises a conductive lead 122 which is connected with an external power supply, and a plurality of data lines 150 for supplying power to the pixel electrodes of the LCD panel. One end of the data lines 150 is coupled with the conductive lead, and the other end is electrically connected with at least one another data line 150 when power is applied. In the invention, a connecting switch is preferred; both ends of the connecting switch are connected with different data lines 150. Thus, each data line 150 is electrically connected with at least one another data line 150 through the connecting switches when power is applied.

There are three conductive leads and three kinds of data lines 150 for respectively controlling three kinds of LCD panel pixel electrodes which correspond to different colors. The same kind of data lines 150 are connected to the same conductive lead; different kinds of data lines 150 are connected to different conductive leads. Generally, a display device employs primary colors to synthesize various color images. Thus, different voltages can be supplied according to requirements of pixels of different colors to achieve the purpose of accurately controlling a tilt angle. One end of the conductive lead is connected with a power-up terminal 123 so as to connect the external power supply.

A TFT 137 is used as the connecting switch. A source electrode and a drain electrode of the TFT 137 are respectively connected with two different data lines 150; a gate electrode of the TFT is connected to a common switching lead 140. One end of the switching lead is connected with a switching terminal 133 so as to connect an external control signal. The pixels of PSVA are controlled by the TFT. The TFT is used as the connecting switch and can be synchronously formed in the process of making the substrate without adding working procedures, thereby reducing production cost.

On the basis of the aforementioned inventive concept, the invention will further be described in detail in accordance the examples.

### EXAMPLE 1

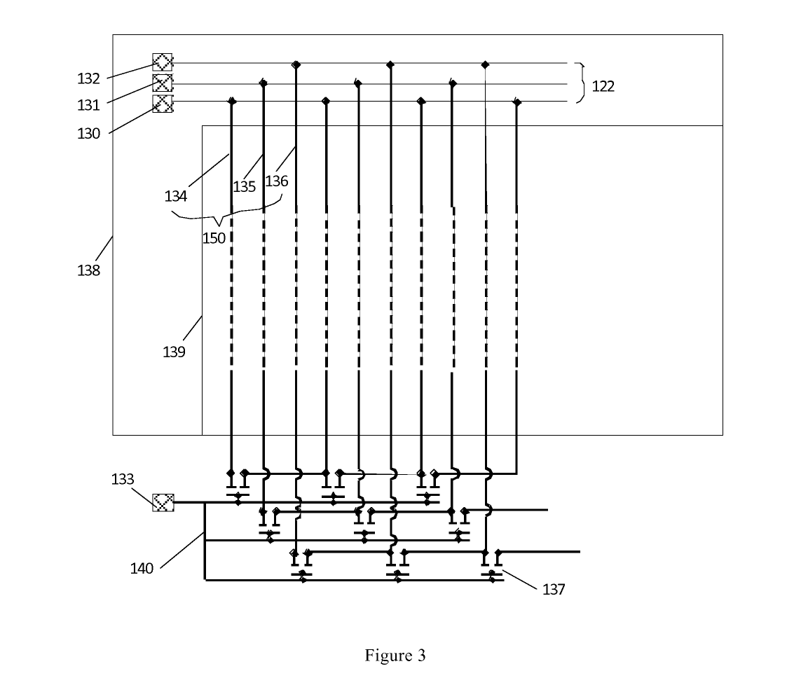

As shown in FIG. 3, a source electrode of a TFT is connected with a drain electrode of an adjacent TFT for controlling the same kind of data lines 150; a drain electrode thereof is connected with a source electrode of another adjacent TFT for controlling the same kind of data lines 150. The source electrodes and the drain electrodes of the TFT are respectively connected with the same kind of two adjacent data lines 150; when all the TFTs are opened, any two data lines 150 of the same kind are mutually short-circuited on one end of the TFTs.

The conductive lead is connected with a power-up terminal 123 which comprises an R (red pixel) terminal, a G (green pixel) terminal, and a B (blue pixel) terminal. One end of the switching lead is connected to one switching terminal 133. One end of the red data lines 134 in the panel figure areas 119 is combined together and connected to the red pixel terminal 130 (R terminal) through the conductive lead 122; the other end of the red data lines 134 extends outwards and is connected to the TFTs. One end of the green data lines 135 in the panel figure areas 119 is combined together and connected to the green pixel terminal 131 (G terminal) through the conductive lead 122; the other end of the green data lines 135 extends outwards and is connected to the TFTs. One end of the blue data lines 136 in the panel figure areas is combined together and connected to the blue pixel terminal 132 (B terminal) through the conductive lead 122; the other end of the blue data lines 136 extends outwards and is connected to the TFTs. When these TFTs are opened, the red data lines 134 are mutually short-circuited on one end of the switching lead, the green data lines 135 are mutually short-circuited on one end of the switching lead, the blue data lines 136 are mutually short-circuited on one end of the switching lead, but any two data lines 150 of different colors are not short-circuited on one end of the switching lead. The gate electrodes of these TFTs are connected to the switching terminal 133 through the switching lead 140.

When the PSVA liquid crystal box is subject to power-up ultraviolet alignment, high voltage is applied to the switching terminal, such as 10 V, 15 V. Because the switching terminal 133 is connected to the gate electrodes of a series of TFTs, these TFTs are in an open mode; both ends of the red, green, and blue data lines are respectively short-circuited together; thus, if any one data line 150 is disconnected, the condition that the whole data line 150 has no electric signal cannot occur; in addition to the disconnecting position, other part of data lines can be subject to normal light alignment.

After the light alignment is finished, these TFTs can be excised through cutting procedures of the liquid crystal box; meanwhile, the conductive lead on the other end can be excised by a laser cutting method or a machine cutting method, so that both ends of the data lines 150 which are originally short-circuited together are separated.

Finally, linear defects become point defects by a frequently-used method of repairing the linear defects with the point defects; if the point defects are bright points, the point defects can be repaired into dark points.

In the example, any two data lines 150 of the same kind can be mutually connected. Thus, as long as one data line 150 of the same kind is normal, the voltage can be transmitted to other disconnected data lines 150, with high reliability.

### EXAMPLE 2

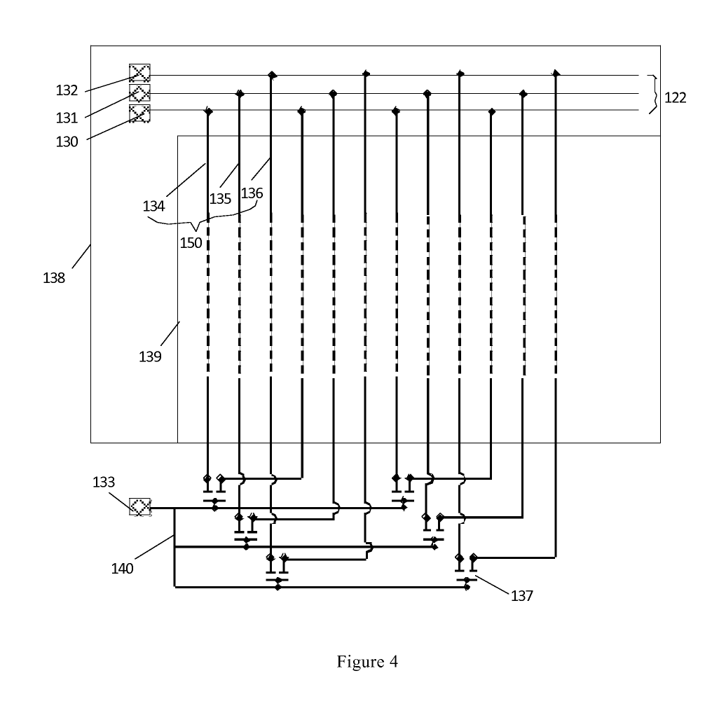

As shown in FIG. 4, two adjacent data lines 150 of the same kind are regarded as one group and respectively connected to a source electrode and a drain electrode of a TFT 137. When all the TFTs are opened, the data lines 150 in different groups are not mutually connected on one end of the TFTs.

The conductive lead is connected with a power-up terminal 123 which comprises an R (red pixel) terminal, a G (green pixel) terminal, and a B (blue pixel) terminal; one end of the switching lead is connected to a switching terminal 133. One end of the red data lines 134 in the panel figure areas 119 is combined together and connected to the R terminal through the conductive lead 122; the other end of the red data lines 134 extends outwards and is connected to the TFT. One end of the green data lines 135 in the panel figure areas 119 is combined together and connected to the G terminal through the conductive lead 122; the other end of the green data lines 135 extends outwards and is connected to the TFT. One end of the blue data lines 136 in the panel figure areas 119 is combined together and connected to the B terminal through the conductive lead 122; the other end of the blue data lines 136 extends outwards and is connected to the TFT. The other end of these data lines is the source electrodes and the drain electrodes of a series of TFTs on the periphery. On one end of the switching lead, two adjacent data lines 150 of the same color are regarded as one group. When these TFTs are opened, two data lines 150 in one group are short-circuited on the end of the switching lead, but data lines 150 of different colors and different groups are not short-circuited. The gate electrodes of these TFTs are connected to the switching terminal 133 through the switching lead 140.

When the PSVA liquid crystal box is subject to power-up ultraviolet alignment, high voltage is applied to the switching terminal, such as 10 V, 15 V. Because the switching terminal 133 is connected to the gate electrodes of a series of TFTs, the TFTs are in an open mode; both ends of the red, green, and blue data lines are respectively short-circuited together; thus, if any one data line 150 is disconnected, the condition that the whole data line 150 has no electric signal cannot occur; in addition to the disconnecting position, other part of data lines can be subject to normal light alignment.

After the light alignment is finished, these TFTs can be excised through cutting procedures of the liquid crystal box; meanwhile, the conductive lead on the other end can be excised by a laser cutting method or a machine cutting method, so that both ends of the data lines 150 which are originally short-circuited together are separated.

Finally, linear defects become point defects by a frequently-used method of repairing the linear defects with the point defects; if the point defects are bright points, the point defects can be repaired into dark points.

In the example, the number of the connecting switches can be reduced. For example, if there are N data lines 150, only N/2 connecting switches are needed.

### EXAMPLE 3

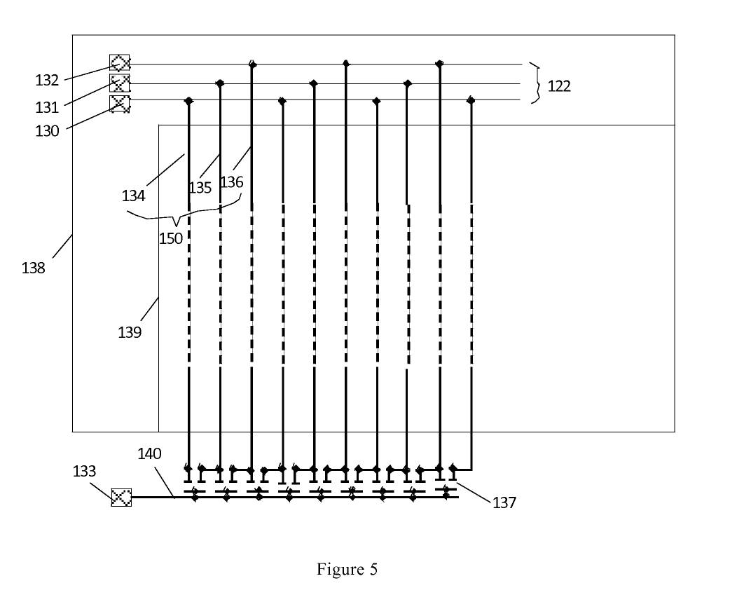

As shown in FIG. 5, a source electrode of a TFT 137 is connected with a drain electrode of an adjacent TFT; a drain electrode thereof is connected with a source electrode of another adjacent TFT. The source electrode and the drain electrode of each TFT are respectively connected with two adjacent data lines 150; when all the TFTs are opened, any two data lines 150 are mutually short-circuited on one end of the TFTs.

The conductive lead is connected with a power-up terminal 123 which comprises an R (red pixel) terminal, a G (green pixel) terminal, and a B (blue pixel) terminal; one end of the switching leads is uniformly connected to one switching terminal 133. One end of the red data lines 134 in the panel figure areas 119 is combined together and connected to the R terminal through the conductive lead 122; the other end of the red data lines 134 extends outwards and is connected to the TFTs. One end of the green data lines 135 in the panel figure areas 119 is combined together and connected to the G terminal through the conductive lead 122; the other end of the green data lines 135 extends outwards and is connected to the TFT. One end of the blue data lines 136 in the panel figure areas 119 is combined together and connected to the B terminal through the conductive lead 122; the other end of the blue data lines 136 extends outwards and is connected to the TFT. When these TFTs are opened, on one end of the switching lead, any two data lines 150 are mutually short-circuited. The gate electrodes of these TFTs are connected to the switching terminal 133 through the switching lead 140.

When the PSVA liquid crystal box is subject to power-up ultraviolet alignment, high voltage is applied to the switching terminal, such as 10 V, 15 V. Because the switching terminal 133 is connected to the gate electrodes of a series of TFTs, the TFTs are in an open mode; both ends of the red, green, and blue data lines are respectively short-circuited together; thus, if any one data line 150 is disconnected, the condition that the whole data line 150 has no electric signal cannot occur; in addition to the disconnecting position, other part of data lines can be subject to normal light alignment.

After the light alignment is finished, these TFTs can be excised through cutting procedures of the liquid crystal box; meanwhile, the conductive lead on the other end can be excised by a laser cutting method or a machine cutting method, so that both ends of the data lines 150 which are originally short-circuited together are separated.

Finally, linear defects become point defects by a frequently-used method of repairing the linear defects with the point defects; if the point defects are bright points, the point defects can be repaired into dark points.

The reliability of the technical scheme is highest. Thus, as long as one data line 150 is normal, the voltage can be transmitted to other disconnected data lines 150. Thus, even if the conductive lead 122 is disconnected, corresponding data lines 150 can obtain voltage from other conductive lead 122.

### EXAMPLE 4

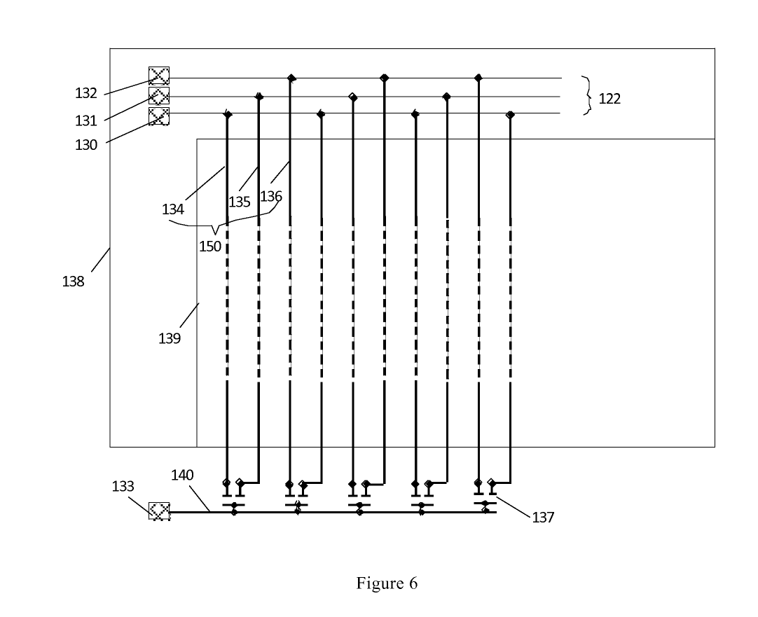

As shown in FIG. 6, two adjacent data lines 150 are regarded as one group and respectively connected to a source electrode and a drain electrode of a TFT 137; when all the TFTs are opened, the data lines 150 of different groups are not mutually connected on one end of the TFTs.

The conductive lead is connected with a power-up terminal 123 which comprises an R (red pixel) terminal, a G (green pixel) terminal, and a B (blue pixel) terminal; one end of the switching leads is uniformly connected to a switching terminal 133.

One end of the red data lines 134 in the panel figure areas 119 is combined together and connected to the R terminal through the conductive lead 122; the other end of the red data lines 134 extends outwards and supplies power to the pixel electrodes of the LCD substrate. One end of the green data lines 135 in the panel figure areas 119 is combined together and connected to the G terminal through the conductive lead 122; the other end of the green data lines 135 extends outwards and is connected to the TFT. One end of the blue data lines 136 in the panel figure areas 119 is combined together and connected to the B terminal through the conductive lead 122; the other end of the blue data lines 136 extends outwards and is connected to the TFT. The other end of these data lines is the source electrodes and the drain electrodes of a series of TFTs on the periphery. On one end of the switching lead, two adjacent data lines 150 are regarded as one group; when these TFTs 137 are opened, two data lines 150 in one group are short-circuited on the end; but the data lines 150 among groups are not short-circuited. The gate electrodes of these TFTs are connected to the switching terminal 133 through the switching lead 140.

When the PSVA liquid crystal box is subject to power-up ultraviolet alignment, high voltage is applied to the switching terminal, such as 10 V, 15 V. Because the switching terminal 133 is connected to the gate electrodes of a series of TFTs, the TFTs are in an open mode; both ends of the red, green, and blue data lines are respectively short-circuited together; thus, if any one data line 150 is disconnected, the condition that the whole data line 150 has no electric signal cannot occur; in addition to the disconnecting position, other part of data lines can be subject to normal light alignment.

After the light alignment is finished, these TFTs can be excised through cutting procedures of the liquid crystal box; meanwhile, the conductive lead on the other end can be excised by a laser cutting method or a machine cutting method, so that both ends of the data lines 150 which are originally short-circuited together are separated.

Finally, linear defects become point defects by a frequently-used method of repairing the linear defects with the point defects; if the point defects are bright points, the point defects can be repaired into dark points.

In this technical scheme, the number of the connecting switches can be reduced. For example, if there are N data lines 150, only N/2 connecting switches are needed. Moreover, even if the conductive lead is also disconnected, corresponding data lines 150 can obtain voltage from other conductive lead.

A method for manufacturing the aforementioned LCD panel comprises the following steps:

A: correspondingly arranging the power-up circuit of the PSVA LCD panel in each panel figure area of an LCD substrate;

B: electrifying the conductive lead, and switching on all the connecting switches for performing power-up ultraviolet alignment; and

C: performing cutting operation around the edges of each panel figure area for excising and cutting off all the connecting switches.

Preferably, laser cutting or machine cutting is used in the step B. This is a specific cutting mode.

In the invention, because different data lines are mutually connected during light alignment, when a data line is disconnected, the non-disconnected part of the data line connected to the conductive lead is continuously supplied with electricity through the conductive lead; the disconnected line on the other end of the data line is supplied with electricity through other normal data lines which are connected with the disconnecting end. Thus, alignment fault is controlled within the range of a disconnected point; the conventional linear defects are reduced to point defects, thereby improving PSVA light alignment effect.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. A power-up circuit of a PSVA LCD panel, comprising: a conductive lead connected with an external power supply, and a plurality of data lines for supplying power to pixel electrodes of an LCD panel; wherein one end of each data line is coupled with said conductive lead, and the other end is electrically connected with at least one another data line when power is applied.

2. The power-up circuit of the PSVA LCD panel of claim 1, wherein said power-up circuit further comprises a connecting switch; one end of said data lines is coupled with said conductive lead, and the other end is electrically connected with at least one another data line through the connecting switch when power is applied; both ends of said connecting switch are connected with different data lines.

3. The power-up circuit of the PSVA LCD panel of claim 1, wherein the conductive lead is three in number and the data lines are three in kind for respectively controlling three kinds of LCD panel pixel electrodes which correspond to different colors; the same kind of data lines is connected to the same conductive lead; and different kinds of data lines are connected to different conductive leads.

4. The power-up circuit of the PSVA LCD panel of claim 2, wherein the conductive lead is three in number and the data lines are three in kind for respectively controlling three kinds of LCD panel pixel electrodes which correspond to different colors; the same kind of data lines is connected to the same conductive lead; and different kinds of data lines are connected to different conductive leads.

5. The power-up circuit of the PSVA LCD panel of claim 2, wherein said connecting switch is a TFT; a source electrode and a drain electrode of said TFT are respectively connected with two different data lines, and a gate electrode is connected to a common switching lead.

6. The power-up circuit of the PSVA LCD panel of claim 5, wherein the source electrode of the TFT is connected with a drain electrode of an adjacent TFT for controlling the same kind of data lines; the drain electrode thereof is connected with a source electrode of another adjacent TFT for controlling the same kind of data lines; the source electrode and the drain electrode of said TFT are respectively connected with the same kind of two adjacent data lines; when all TFTs are opened, any two data lines of the same kind are mutually short-circuited on one end of said TFTs.

7. The power-up circuit of the PSVA LCD panel of claim 5, wherein two adjacent data lines of the same kind are regarded as one group and respectively connected to the source electrode and the drain electrode of the TFT; when all TFTs are opened, the data lines of different groups are not mutually connected on one end of said TFTs.

8. The power-up circuit of the PSVA LCD panel of claim 5, wherein the source electrode of the TFT is connected with a drain electrode an adjacent TFT, the drain electrode thereof is connected with a source electrode another adjacent TFT; the source electrode and the drain electrode of each TFT are respectively connected with two adjacent data lines; when all the TFTs are opened, any two data lines are mutually short-circuited on one end of said TFTs.

9. The power-up circuit of the PSVA LCD panel of claim 5, wherein two adjacent data lines are regarded as one group and respectively connected to the source electrode and the drain electrode of the TFT; when all TFTs are opened, the data lines of different groups are not mutually connected on one end of said TFTs.

10. An LCD substrate, comprising: a first substrate and a second substrate which are mutually opposite; wherein a plurality of panel figure areas are arranged between said first substrate and said second substrate; the power-up circuit of the PSVA LCD panel of claim 1 is arranged correspondingly in each panel figure area.

11. The LCD substrate of claim 10, wherein said power-up circuit further comprises a connecting switch; one end of said data lines is coupled with said conductive lead, and the other end is electrically connected with at least one another data line through the connecting switch when power is applied; both ends of said connecting switch are connected with different data lines.

12. The LCD substrate of claim 11, wherein the conductive lead is three in number and the data lines are three in kind for respectively controlling three kinds of LCD panel pixel electrodes which correspond to different colors; the same kind of data lines is connected to the same conductive lead; different kinds of data lines are connected to different conductive leads.

13. The LCD substrate of claim 11, wherein said connecting switch is a TFT; a source electrode and a drain electrode of said TFT are respectively connected with two different data lines, and a gate electrode is connected to a common switching lead.

14. The LCD substrate of claim 13, wherein the source electrode of the TFT is connected with a drain electrode of an adjacent TFT for controlling the same kind of data lines; the drain electrode thereof is connected with a source electrode of another adjacent TFT for controlling the same kind of data lines; the source electrode and the drain electrode of said TFT are respectively connected with the same kind of two adjacent data lines; when all TFTs are opened, any two data lines of the same kind are mutually short-circuited on one end of said TFTs.

15. The LCD substrate of claim 13, wherein two adjacent data lines of the same kind are regarded as one group and respectively connected to the source electrode and the drain electrode of the TFT; when all the TFTs are opened, the data lines of different groups are not mutually connected on one end of said TFTs.

16. The LCD substrate of claim 13, wherein the source electrode of the TFT is connected with a drain electrode an adjacent TFT, the drain electrode thereof is connected with a source electrode another adjacent TFT; the source electrode and the drain electrode of each TFT are respectively connected with two adjacent data lines; when all the TFTs are opened, any two data lines are mutually short-circuited on one end of said TFTs.

17. The LCD substrate of claim 13, wherein two adjacent data lines are regarded as one group and respectively connected to the source electrode and the drain electrode of the TFT; when all TFTs are opened, the data lines of different groups are not mutually connected on one end of said TFTs.

18. A method for manufacturing an LCD panel, comprising the following steps:
A: correspondingly arranging the power-up circuit of the PSVA LCD panel of claim 1 in each panel figure area of an LCD substrate;
B: electrifying the conductive lead, and switching on all connecting switches for performing power-up ultraviolet alignment; and
C: performing cutting operation around edges of each panel figure area for excising and cutting off all the connecting switches.
